(19) United States
(12) Patent Application Publication
(10) Pub. No.: US 2005/0077869 A1
(43) Pub. Date: Apr. 14, 2005

(54) Combinational charger

(76) Inventor: Wen Hsiang Yueh, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/683,394

(22) Filed: Oct. 14, 2003

(51) Int. Cl. H02J 7/00

(52) U.S. Cl. 320/114

(57) ABSTRACT

A combinational charger is used as a spare power source of a hand-held electronic device and also used for charging the hand-held electronic device in a DC way. The combinational charger comprises at least a rechargeable battery, a charging connector, a transmission interface and a switch. The charging connector is movably engaged with a power source port of the hand-held electronic device. The transmission interface is movably engaged with a connection interface of a host system to capture power via the connection interface. The switch is used to switch the rechargeable battery to the transmission interface to let a power source on the connection interface charge the rechargeable battery, or switch the rechargeable battery to the charging connector to let the rechargeable battery charge a battery of the hand-held electronic device.

### FIELD OF THE INVENTION

The present invention relates to a combinational charger and, more particularly, to a charger having a USB connection interface, which is used as a spare power source of a hand-held electronic device and also used for charging the hand-held electronic device in a DC way.

### BACKGROUND OF THE INVENTION

Along with miniaturization and diversification of electronic products, many hand-held electronic devices such as personals digital assistants (PDAs) and digital still cameras use rechargeable batteries as their primary power source. In order to directly use a charging circuit of hand-held electronic device itself for charging a rechargeable battery, manufacturers usually provide a power adaptor to convert the common electric AC power into a constant DC voltage power used by the hand-held electronic device.

However, the power adaptor can only be used in situations where the common electric AC power is available, and it needs to stay at the same place during charging, resulting in much inconvenience of the user. Therefore, a charger using a USB connection interface for charging has been proposed. For instance, R.O.C. Pat. No. 479,393discloses a USB automatic charger and the operational method thereof, wherein a device having a transmission interface with a rechargeable battery is provided, and the device is connected with a USB interface of a host system. Through the connection, the host system can provide power for charging the rechargeable battery in the device. Also, R.O.C. Pat. No. 443,661 discloses a mobile phone charger having a computer USB interface, wherein a USB connection interface of a host system is used to provide power for charging a mobile phone having a USB connection interface.

Although the above chargers having a USB connection interface can make use of a computer USB connection interface for charging, they need to stay at some place during charging and can't be taken along with a user.

Accordingly, the present invention aims to propose a combinational charger to let a user be able to charge a hand-held electronic device at any situation.

### SUMMARY OF THE INVENTION

The primary object of the present invention is to provide a combinational charger for charging a hand-held electronic device at any time and at any place.

Another object of the present invention is to provide the above combinational charger, which can make use of a USB connection interface to charge a hand-held electronic device.

Yet another object of the present invention is to provide the above combinational charger, whose USB connection interface further combines the storage function of a flash drive.

Still yet another object of the present invention is to provide the above combinational charger, whose flash drive further combines the MP3 walkman function and the recording function.

To achieve the above objects, a combinational charger of the present invention comprises at least a rechargeable battery, a charging connector, a transmission interface and a switch. The charging connector is movably engaged with a power source port of the hand-held electronic device. The transmission interface is movably engaged with a connection interface of a host system to capture power via the connection interface. The switch is used to switch the rechargeable battery to the transmission interface to let a power source on the connection interface charge the rechargeable battery, or switch the rechargeable battery to the charging connector to let the rechargeable battery charge a battery of the hand-held electronic device.

The various objects and advantages of the present invention will be more readily understood from the following detailed description when read in conjunction with the appended drawing, in which:

### BRIEF DESCRIPTION OF THE DRAWINGS

FIG. 1 is a perspective view of a first embodiment of the present invention;

FIG. 2 is a circuit block diagram of the first embodiment of the present invention;

FIG. 3 is a wiring diagram of the switch of the present invention;

FIG. 4 is a circuit diagram of a second embodiment of the present invention; and

FIG. 5 is a perspective view of the second embodiment of the present invention.

### DETAILED DESCRIPTION OF THE PREFERRED EMBODIMENTS

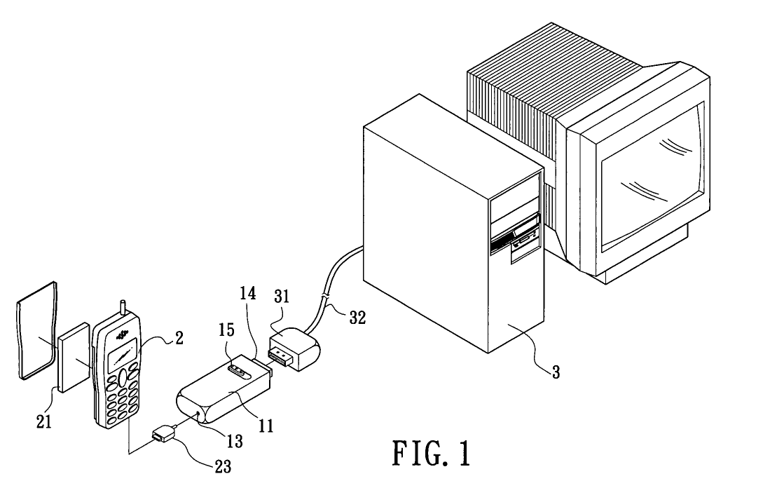

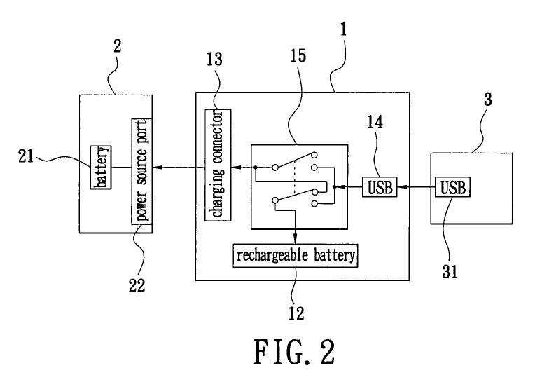

As shown in FIGS. 1 and 2, a combinational charger 1 of the present invention is mainly used to charge a battery 21 in a hand-held electronic device 2. The hand-held electronic device 2 can be a mobile phone, an MP3 walkman, a PDA or a digital still camera. The present invention can be movably connected to a connection interface 31 of a host system 3. The host system 3 can be a computer. The connection interface 31 can be a USB interface, an IEEE 1394 interface or a PS2 interface.

The combinational charger 1 has a shell 11 with a receiving space formed therein. At least a rechargeable battery 12 is arranged in the receiving space. Due to the progress of the of rechargeable battery technology, existent rechargeable batteries have already the advantages of high capacity and long endurance. The present invention makes use of a fully-charged rechargeable battery 12 as a spare power source of the hand-held electronic device 2 and for charging the battery 21 therein. The combinational charger 1 can be taken along with a user for charging at any time and at any place.

A charging connector 13, a transmission interface 14 and a switch 15 are disposed on the shell 11, the charging connector 13 can be movably engaged with a power source port 22 of the hand-held electronic device 2. The power source port 22 is electrically connected to the battery 21 in the hand-held electronic device 2. The transmission interface 14 can be movably engaged with the connection interface 31 of the host computer 3 to capture power via the connection interface 31. The transmission interface can be a USB interface, an IEEE 1394 interface or a PS2 interface.

The present invention makes use of the switch 15 to switch the rechargeable battery 12. The switch 15 can be used to switch the rechargeable battery 12 to electrically connect the charging connector to let the rechargeable battery 12 charge the battery 21 of the hand-held electronic device 2, or can be used to switch the rechargeable battery to electrically connect the transmission interface 14 to let the transmission interface 14 capture power via the connection interface 31 and then charge the rechargeable battery 12.

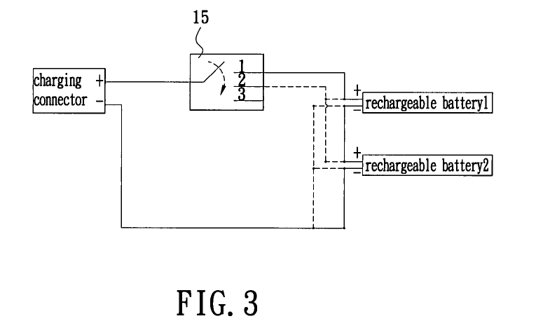

Because there are various kinds of the hand-held electronic devices 2, the voltages of the batteries thereof differ. For instance, the voltage of batteries of mobile phones is about 3.6V, while the voltage of batteries of digital still cameras is about 7V. Therefore, the present invention makes use of two rechargeable batteries of 3.7V, which can be series- or parallel-connected together to accomplish an output voltage of 3.7V or 7.4V. For most existent rechargeable batteries 12, a current-limiting protection circuit is generally disposed therein for limiting the charging current to the rechargeable battery 12. Therefore, the battery 21 of the hand-held electronic device 2 can be charged with a higher voltage. The present invention also uses the switch 15 to switch the two rechargeable batteries 12 to be series- or parallel-connected for changing the charging voltage or current outputted to the hand-held electronic device 2, as shown in FIG. 3.

As shown in FIG. 1, because the connectors of the power source ports 22 of various kinds of the hand-held electronic devices 2 differ from one another, a charging adaptor 23 is movably engaged with the charging connector 13 and the power source port 22 of the hand-held electronic device 2. The charging adaptor 23 is matched and compatible with the connectors of the power source port 22 of various kinds of the hand-held electronic devices 2. The transmission interface 14 can use a transmission line 32 to be movably and electrically engaged with the connection interface 31 of the host system 3.

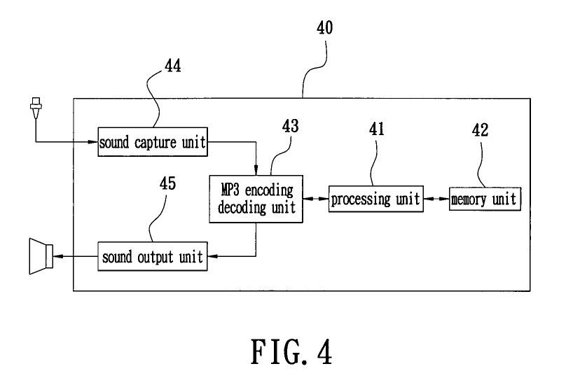

Besides, the combinational charger 1 of the present invention can combine the flash disk function and the MP3 function. As shown in FIG. 4, a circuit board 40 is arranged in the receiving space in the shell 11. A processing unit 41, a memory unit 42, an MP3 encoding/decoding unit 43, a sound capture unit 44 and a sound output unit 45 are provided on the circuit board 40. The memory unit 42 can be a nonvolatile memory for storing digital data. The processing unit 41 is electrically connected to the transmission interface 14 and the memory unit 42, and can control and read digital data in the memory unit 42 and store digital data into the memory unit 42, and can transmit the digital data in the memory unit 42 to the host system 3 via the transmission interface 14.

The sound capture unit 44 can be a microphone for capturing external sound signals. The sound output unit 45 can be a loudspeaker or an earphone for outputting sound signals. The MP3 encoding/decoding unit 43 is connected with the processing unit 41, the sound capture unit 44 and the sound output unit 45, and can be used to encode external sound signals captured by the sound capture unit 44 into MP3 digital data stored into the memory unit 42 through the processing unit 41, or can be used to decode the MP3 digital data stored in the memory unit 42 into sound signals outputted to the sound output unit 45.

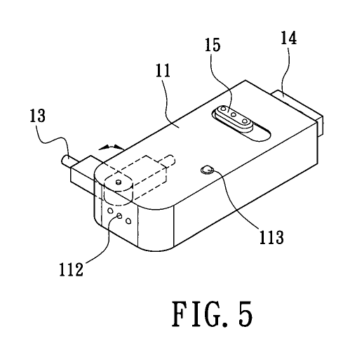

As shown in FIG. 5, the charging connector 13 of the present invention can further be designed to be of a movable hidden type. A movable pivot 131 is disposed at the connection place of the charging connector 13 and the shell 11, and a receiving groove 111 is formed on the shell 11 so that the charging connector 13 can be movably turned out of the shell 11 or received in the receiving groove 111.

As shown in FIG. 5, at least a light-emitting component 112 can further provided on the shell 11. The light-emitting component 112 can be a high-brightness light-emitting diode (LED) or a small light bulb. A light emission switch 113 is electrically connected with the light-emitting component 112 and the rechargeable battery 12 for opening or closing electricity of the rechargeable battery 12 supplied to the light-emitting component 112

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A combinational charger for charging a battery in a hand-held electronic device and movably connected to a connection interface of a host system, said combinational charger comprising:
a shell having a receiving space therein;
at least a rechargeable battery arranged in said receiving space;
a charging connector arranged on said shell and movably engaged with a power source port of said hand-held electronic device;
a transmission interface arranged on said shell and movably engaged with said connection interface of said host system to capture power via said connection interface; and
a switch arranged on said shell and used to switch said rechargeable battery to said transmission interface to let a power source on said connection interface charge said rechargeable battery or switch said rechargeable battery to said charging connector to let said rechargeable battery charge said battery of said hand-held electronic device

2. The combinational charger as claimed in claim 1 further comprising a charging adapting line, which is movably engaged with said charging connector and said power source port of said hand-held electronic device, and is matched and compatible with power source ports of various hand-held electronic devices.

3. The combinational charger as claimed in claim 1, wherein a movable pivot is disposed at the connection place of said charging connector and said shell, and a receiving groove is formed on said shell so that said charging connector can be movably turned out of said shell or received in said receiving groove.

4. The combinational charger as claimed in claim 1, wherein said hand-held electronic device can be a mobile phone, an MP3 walkman, a PDA or a digital still camera.

5. The combinational charger as claimed in claim 1 further comprising a transmission line for electrically connect said transmission interface with said connection interface of said host system.

6. The combinational charger as claimed in claim 1, wherein said host system can be a computer.

7. The combinational charger as claimed in claim 1, wherein said connection interface can be a USB interface, an IEEE 1394 interface or a PS2 interface.

8. The combinational charger as claimed in claim 1, wherein if there are a plurality of said rechargeable batteries electrically connected to said switch, said switch can switch said rechargeable batteries to be series- or parallel-connected so as to change the charging voltage or current outputted to said hand-held electronic device.

9. The combinational charger as claimed in claim 1 further comprising a current-limiting protection circuit, which is electrically connected to said rechargeable battery and used for limiting the charging current of the power source of said transmission interface to said rechargeable battery.

10. The combinational charger as claimed in claim 9, wherein said current-limiting protection circuit is provided in said rechargeable battery.

11. The combinational charger as claimed in claim 1, wherein said transmission interface can be a USB interface, an IEEE 1394 interface or a PS2 interface.

12. The combinational charger as claimed in claim 1 further comprising a circuit board arranged in said receiving space in said shell, said circuit board comprising:
a memory unit for storing digital data; and
a processing unit electrically connected to said transmission interface and said memory unit and capable of controlling and reading digital data in said memory unit or storing digital data into said memory unit and also capable of transmitting said digital data to said host system via said transmission interface.

13. The combinational charger as claimed in claim 12, wherein said circuit board further comprising:
a sound capture unit for capturing external sound signals;
a sound output unit for outputting sound signals; and
an MP3 encoding/decoding unit connected to said processing unit, said sound capture unit and said sound output unit and capable of encoding external sound signals captured by said sound capture unit into MP3 digital data stored into said memory unit through said processing unit or decoding MP3 digital data stored in said memory unit into sound signals outputted to said sound output unit.

14. The combinational charger as claimed in claim 13, wherein said sound capture unit is a microphone.

15. The combinational charger as claimed in claim 13, wherein said sound output unit is a loudspeaker or an earphone.

16. The combinational charger as claimed in claim 1 further comprising:
at least a light emitting component arranged on said shell; and
a light emission switch electrically connected to said light emitting component and said rechargeable battery and capable of opening or closing electricity of said rechargeable battery supplied to said light emitting component.

17. The combinational charger as claimed in claim 16, wherein said light emitting component is a high-brightness light-emitting diode or a small light bulb.
